(19) United States
(12) Patent Application Publication
(10) Pub. No.: US 2025/0087732 A1
(43) Pub. Date: Mar. 13, 2025

(54) METHOD FOR REDUCING TEMPERATURE PEAKS IN A FUEL CELL

(71) Applicant: Aerostack GmbH, Dettingen an der Erms (DE)

(72) Inventors: Markus SCHUDY, Dettingen an der Erms (DE); Marcus-Benedict BUNTZ, Dettingen an der Erms (DE); Christoph ZIEGLER, Dettingen an der Erms (DE)

(21) Appl. No.: 18/883,019

(22) Filed: Sep. 12, 2024

(30) Foreign Application Priority Data
Sep. 13, 2023 (DE) 102023124655.0

(51) Int. Cl. H01M 8/04701; H01M 8/04302; H01M 8/04746

(52) U.S. Cl. CPC H01M 8/04723; H01M 8/04302; H01M 8/04768

(57) ABSTRACT

A method and system for reducing temperature peaks during start-up of a fuel cell with a two-phase cooling system, the method including setting a saturation pressure of a coolant, via a pressure controller, to a first saturation pressure such that a maximum temperature of a coolant induced by boiling delay is below a maximum operating temperature of the fuel cell, starting the fuel cell, in response to the maximum temperature of the coolant induced by boiling delay being exceeded, setting the saturation pressure of the coolant, via the pressure controller, to a second saturation pressure, wherein the second saturation pressure is higher than the first saturation pressure.

### TECHNICAL FIELD

The disclosure herein relates generally to the technical field of aviation. In particular, the description relates to a method for reducing temperature peaks in a fuel cell as well as an associated system and an aircraft comprising such a system.

### BACKGROUND

Fuel cells are a possible solution for emission-free propulsion or emission-free on-board power supply (APU=Auxiliary Power Unit) for aircraft, for example. Polymer electrolyte fuel cells (PEMFC) generate power and electricity through the electrochemical reaction of hydrogen and oxygen to form water. This reaction generates heat, which must be dissipated. In commercial fuel cell stacks, this is usually done by liquid cooling. One possible alternative, which offers considerable weight-saving potential at the drive system level or on-board power supply system level, is to replace liquid cooling with a two-phase cooling circuit. The latent heat of vaporization is used to dissipate large amounts of heat from the fuel cells. In addition, the high heat transfer coefficient improves the performance of the cooling system compared to single-phase cooling. The two-phase cooling circuit is based on the phase transitions in the fuel cells (evaporator) and in the heat exchanger to the environment (condenser).

During two-phase cooling, especially during the formation of the boiling core required for this, temperature peaks occur, which are referred to as “liquid superheating” or boiling delay. This effect leads to higher temperatures at the interface, as the boiling process has not yet been fully initiated. As soon as a certain superheating above the saturation point is reached, boiling begins and the temperature drops to the saturation temperature. This is a temporary effect that initiates the boiling process.

This effect of the boiling delay can lead to a higher degradation rate of the fuel cell due to the temperature peak reached.

### SUMMARY

It can be regarded as the object of the disclosure herein to provide a method for optimizing the operation and increasing the durability of fuel cells.

This object is achieved by the subject matter and embodiments disclosed herein.

According to one aspect, a method for reducing temperature peaks during start-up of a fuel cell with a two-phase cooling system comprises the following steps:
setting a saturation pressure of a coolant, via a pressure controller, to a first saturation pressure in such a way that a maximum temperature of a coolant induced by boiling delay is below a maximum operating temperature of the fuel cell;
starting the fuel cell;
in response to the maximum temperature of the coolant induced by boiling delay being exceeded, setting the saturation pressure of the coolant, via the pressure controller, to a second saturation pressure, wherein the second saturation pressure is higher than the first saturation pressure.

In two-phase flows, the saturation temperature is dependent on the pressure. The proposed operating strategy is therefore to set the maximum temperature of the boiling delay during the start-up phase below a temperature limit of the cell components by lowering the saturation pressure in the cooling system. Once the peak value is exceeded and the boiling process is initiated, the setpoint of the pressure controller can be increased to the nominal operating pressure/temperature.

One advantage of this method for reducing temperature peaks during the start-up of a fuel cell with a two-phase cooling system is that it enables effective monitoring and control of the saturation pressure and thus the temperature of the coolant.

Setting the saturation pressure of the coolant to an initial saturation pressure that is below the maximum operating temperature of the fuel cell ensures that the undesirable effect of boiling delay at excessively high temperatures and thus overheating above the set boiling temperature is avoided. This reduces the risk of temperature peaks that can occur during the start-up process.

After starting the fuel cell, the process continuously monitors the temperature of the coolant. If the maximum temperature induced by boiling delay is exceeded, the saturation pressure of the coolant is adjusted by using the pressure controller. The saturation pressure is set to a second, higher saturation pressure. This allows increased heat dissipation through the coolant, resulting in improved cooling performance and effectively controlling the temperature of the fuel cell.

The advantage of this approach lies in its ability to prevent or reduce temperature peaks during the start-up process. By adjusting the saturation pressure in good time, optimum cooling performance can be ensured without overheating due to boiling delay above the targeted operating temperature. This contributes to the stability and longevity of the fuel cell and enables smooth operation of the system.

In summary, the method described enables precise control of the saturation pressure of the coolant in order to minimize temperature peaks during the start-up process of a fuel cell. This leads to improved reliability, performance and service life of the fuel cell as well as to an overall optimized operating efficiency of the fuel cell system.

According to one embodiment, the pressure controller is an accumulator.

The use of an accumulator as a pressure controller offers several advantages. It allows the saturation pressure to be adjusted quickly and precisely in order to respond to changes in operating conditions and requirements. This ensures efficient cooling and optimum performance of the fuel cell.

In addition, the accumulator helps to stabilize the pressure in the two-phase cooling system. By buffering pressure fluctuations and maintaining a constant pressure level, an even supply of coolant is ensured, resulting in improved heat transfer and cooling.

The accumulator also offers a certain degree of redundancy and safety. It can serve as a reservoir for additional coolant and compensate for unforeseen fluctuations in system pressure. This minimizes potential damage to the fuel cell due to pressure peaks or drops.

According to one embodiment, the accumulator is connected to an outlet of the fuel cell and is set up to separate a vapor and liquid phase of the coolant from each other. The separation of the vapor and liquid phases is key for two-phase cooling.

According to one embodiment, the accumulator is set up to adjust the temperature of the coolant.

The use of an accumulator as a pressure controller with adjustable temperature offers several advantages. By being able to adjust the temperature of the accumulator, the saturation pressure of the coolant can be precisely controlled. This enables effective cooling of the fuel cell and avoids temperature peaks during operation.

According to one embodiment, the accumulator is set up to adjust the pressure of the coolant.

The use of an accumulator as a pressure controller with adjustable pressure also offers various advantages. The ability to adjust the pressure in the accumulator means that the saturation pressure and thus the temperature of the coolant can be precisely controlled to meet the requirements of the fuel cell. This enables efficient cooling. Another advantage of a pressure-controlled accumulator is the ability to immediately set an evaporation pressure.

The adjustable pressure or temperature function of the accumulator also offers flexibility in adapting the cooling system to different operating conditions and requirements. Depending on the specific requirements, the pressure can be adjusted accordingly to ensure optimum cooling and performance of the fuel cell.

Overall, the use of an accumulator as a pressure controller with adjustable temperature or adjustable pressure enables precise control of the saturation pressure in the two-phase cooling system. This helps to improve the performance, efficiency and reliability of the fuel cell system and supports stable and safe operation.

According to one embodiment, the pressure controller is a combination of a pump and a throttle valve.

The use of a combination of a pump and a throttle valve as a pressure controller offers various advantages. The pump enables active control of the coolant pressure by feeding the coolant into the system at a specific speed and pressure. This allows the saturation pressure of the coolant to be precisely controlled in order to maintain the optimum operating temperature of the fuel cell.

At the same time, a combination of a pump and a throttle valve offers the possibility of savings in weight and installation space requirements of the cooling system by reducing the required accumulator size or eliminating the accumulator completely.

The throttle valve serves as a control valve to limit the flow of coolant and regulate the pressure. The pressure in the system can be controlled and adjusted by adjusting the throttle valve. This enables precise control of the saturation pressure in the cooling system in order to meet the requirements of the fuel cell and avoid temperature peaks.

In addition, the use of a combination of pump and throttle valve enables continuous monitoring and control of the coolant pressure. The system can react to changes in the operating conditions and adjust the pressure accordingly to ensure stable cooling and safe operation of the fuel cell.

According to one embodiment, the first saturation pressure is in a range from 0 bar to 10 bar, preferably 0 bar to 5 bar, particularly preferably 1.25 bar.

According to one embodiment, the second saturation pressure is in a range from 0 bar to 10 bar, preferably 0 bar to 5 bar, particularly preferably 3 bar.

According to one embodiment, the maximum temperature of the coolant induced by boiling delay is 50% to 100% of the operating temperature, preferably 60% to 90%, particularly preferably 70% to 80%.

According to one embodiment of the fuel cell system, methanol and/or ethanol is used as a coolant. This choice of coolant offers several advantages for the system.

Methanol and ethanol have a high thermal conductivity, which means that they can efficiently dissipate heat from the fuel cells and the bipolar plate. This enables effective cooling of the components and keeps the operating temperature of the fuel cell at an optimum level.

Furthermore, methanol and ethanol have low boiling points. This is advantageous as they can evaporate quickly when they flow through the coolant channels. The vaporization absorbs heat from the components, which leads to effective cooling. In particular, the combination of boiling temperature and saturation pressure suitable for the operation of the fuel cell is advantageous.

Furthermore, methanol and ethanol have a high enthalpy of vaporization. This means that very small mass flows can be realized in the system, which reduces pressure loss. As a result, pipes and pumps can be dimensioned smaller than with liquid cooling, which leads to a reduction in the weight of the system.

According to one aspect, a system for operating a fuel cell with a two-phase cooling system, wherein the system is set up to perform a method for reducing temperature peaks during start-up, comprises the following. At least one fuel cell, a pressure controller, a heat exchanger and a coolant circuit. The coolant circuit is set up to cool the fuel cell by the phase transition of the coolant. The pressure controller is set up to set a saturation pressure of a coolant contained in the coolant circuit.

The system comprises at least one fuel cell or fuel cell stack, which is responsible for generating energy from the fuel fed into the system. A two-phase cooling system is used to cool the fuel cell effectively. This cooling system enables efficient heat dissipation and helps to stabilize the operating temperature.

A key component of the system is the pressure controller, which is responsible for controlling the saturation pressure of the coolant fed into the coolant circuit. The saturation pressure is set so that the maximum temperature of the coolant remains below the maximum operating temperature of the fuel cell during the start-up process. This prevents undesirable temperature peaks and ensures optimum cooling performance.

The coolant circuit is specially designed to enable efficient distribution and circulation of the coolant. The coolant is pumped through the fuel cell and the two-phase cooling system to dissipate the heat generated and ensure even cooling.

By combining these components and precisely adjusting the saturation pressure of the coolant during the start-up process, the system described can effectively regulate the temperature of the fuel cell and thus improve its service life and performance. The reduction of temperature peaks thus helps to minimize thermal loads and create a reliable and stable operating environment for the fuel cell.

Overall, the system described enables efficient cooling of the fuel cell with a two-phase cooling system and helps to optimize the performance and service life of the fuel cell. This is crucial for the reliable operation of the fuel cell system and its use in various fields such as transportation, energy storage and many other applications.

According to one aspect, an aircraft comprises a system of the described kind. The system may also be expressly used in other systems, such as motor vehicles, watercraft, spacecraft, or other units powered by a fuel cell. By integrating this system into the aircraft, a sustainable and

environmentally friendly energy source is provided for the aircraft's propulsion or on-board power supply. The fuel cell enables high energy efficiency and at the same time reduces emissions compared to conventional combustion engines. The two-phase cooling system ensures efficient cooling and contributes to the reliability and longevity of the fuel cell system.

By using this system in the aircraft, a longer flight duration and improved performance can be achieved. It also reduces the environmental impact and offers a sustainable alternative to conventional fuel sources. The aircraft with the integrated fuel cell system thus contributes to cleaner and more environmentally friendly aviation.

According to one embodiment, the method can also be supplemented by the following method steps for starting a fuel cell at temperatures below 0° Celsius, since at these temperatures the avoidance of temperature peaks is particularly relevant for the cold material:
starting the fuel cell,
activating the pump after a defined period of time, wherein the coolant is substantially present in the gas phase within the fuel cell during the defined period of time.

Temperatures below freezing lead to ice formation in the gas ducts. For this reason, the time to reach temperatures above 0° C. is considered a crucial factor and a reduction of the thermal mass to be heated is considered advantageous. To speed up this process compared to liquid cooling, the technical solution of utilizing the two-phase state of the coolant in the fuel cell and precisely controlling the coolant pump is proposed.

The additional method steps described for starting a fuel cell at temperatures below 0° C. with a two-phase cooling system thus provides an effective method of activating and operating the fuel cell in cold environments. The two-phase cooling system uses a special pump to deliver the coolant, wherein the coolant is at least partially present in a gas phase.

The start-up process begins with starting the fuel cell according to the usual procedures. After a defined period of time, which is required for the necessary activation of the fuel cell, the pump is activated. During this defined period, the coolant is substantially present in the gas phase within the fuel cell.

This approach achieves several advantages. Firstly, the use of a two-phase cooling system enables efficient heat dissipation and ensures optimum cooling of the fuel cell, even at low temperatures. Secondly, the activation of the pump after a defined period of time enables a shortened start-up time for the fuel cell with a low thermal mass before the coolant enters undercooled in order to shorten the start-up time or warm-up time. If the coolant is in the gas phase, the coolant has a lower density than the liquid phase. This lower density results in a lower thermal mass, which leads to faster heating with the same heat input.

The use of this method therefore offers a reliable way of successfully starting and operating a fuel cell even at cold temperatures. It enables efficient cooling and contributes to the long-term stability and performance of the fuel cell at low temperatures. By ensuring optimal operation of the fuel cell in cold environments, the usability and reliability of the system is improved.

Such a method for reducing temperature peaks during start-up and also for starting a fuel cell at temperatures below 0° C. can be implemented in particular with a system described for operating a fuel cell with a two-phase cooling system.

### BRIEF DESCRIPTION OF THE DRAWINGS

In the following, example embodiments of the disclosure herein are described in greater detail with reference to the accompanying drawings. The illustrations are schematic and not to scale. Like reference signs refer to like or similar elements. In the drawings:

FIG. 1 shows a flow diagram of a method for reducing temperature peaks during the start-up of a fuel cell with a two-phase cooling system;

FIG. 2A shows a system for operating a fuel cell with a two-phase cooling system according to a first embodiment;

FIG. 2B shows a system for operating a fuel cell with a two-phase cooling system according to a second embodiment;

FIG. 3 shows an aircraft with a system for operating a fuel cell with a two-phase cooling system; and

FIG. 4 shows two graphical representations of temperature curves over time.

### DETAILED DESCRIPTION

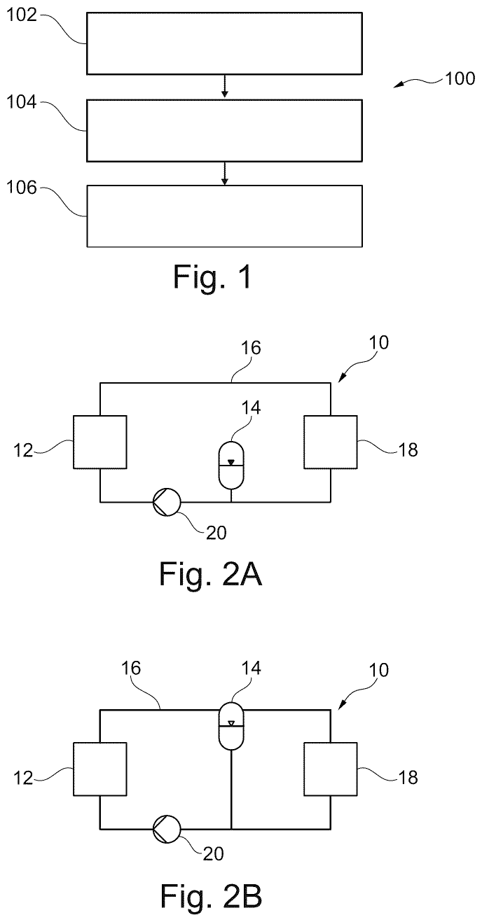

FIG. 1 shows a flow diagram of a method 100 for reducing temperature peaks during start-up of a fuel cell with a two-phase cooling system, the method comprising the following steps: First, the saturation pressure of a coolant is set to a first saturation pressure 102 via a pressure controller 14. This first saturation pressure is selected such that the maximum temperature of the coolant induced by boiling delay is below the maximum operating temperature of the fuel cell.

After the saturation pressure has been set, the fuel cell is started as represented by 104. During the start-up process, a boiling delay can occur, which can lead to an increased temperature of the coolant. After the temperature peak at a first saturation pressure 102 has been exceeded, the saturation pressure of the coolant is set to a second saturation pressure 106 via the pressure controller 14. This second saturation pressure is higher than the first saturation pressure and enables effective cooling of the fuel cell close to its maximum operating temperature.

By specifically adjusting the saturation pressure of the coolant, the method can ensure precise control of temperatures during the start-up process and thus improve the operational reliability and service life of the fuel cell.

FIGS. 2A and 2B each show a system 10 for operating a fuel cell 12 with a two-phase cooling system, which is designed to ensure efficient cooling of the fuel cell and to reduce temperature peaks during start-up. The system comprises several components that operate in an integrated coolant circuit 16 with a pump 20.

The central component of the system is the fuel cell 12, which converts chemical energy into electrical energy. A two-phase cooling system is used to ensure the optimum operating temperature of the fuel cell 12. This system uses a coolant, which can be present in both liquid and gaseous phases, to efficiently dissipate the heat.

A pressure controller 14 is integrated to control the coolant circuit. This module enables precise adjustment of the saturation pressure of the coolant in the coolant circuit 16. By controlling the saturation pressure, the cooling capacity can be optimized and the temperature peaks in the form of boiling delay during the start-up process can be reduced.

The system 10 operates in a continuous circuit in which the coolant flows through the fuel cell 12 and absorbs the heat generated. The coolant is then cooled via the heat exchanger 18 and fed back into the coolant circuit 16. This ensures constant cooling of the fuel cell 12 and prevents overheating.

The main difference between the embodiments of FIGS. 2A and 2B can be seen in the fact that the accumulator/collector is connected to the return line, allowing the gas phase to mix with the liquid phase. In this embodiment, a condenser bypass is used to minimize the thermal mass of a mass flow circulating through the fuel cell. A condenser bypass is a device or arrangement that allows a portion of the mass flow or coolant to bypass the condenser instead of passing it through the condenser. The condenser bypass thus directs the coolant past the condenser. This reduces the thermal mass of the circulating coolant in the circuit and there is no unnecessary heat dissipation to the environment during the start-up process.

The system 10 for operating a fuel cell with a two-phase cooling system offers efficient cooling, improved performance and a longer service life for the fuel cell 12. It enables reliable operation even at extreme temperatures and ensures stable and effective power generation.

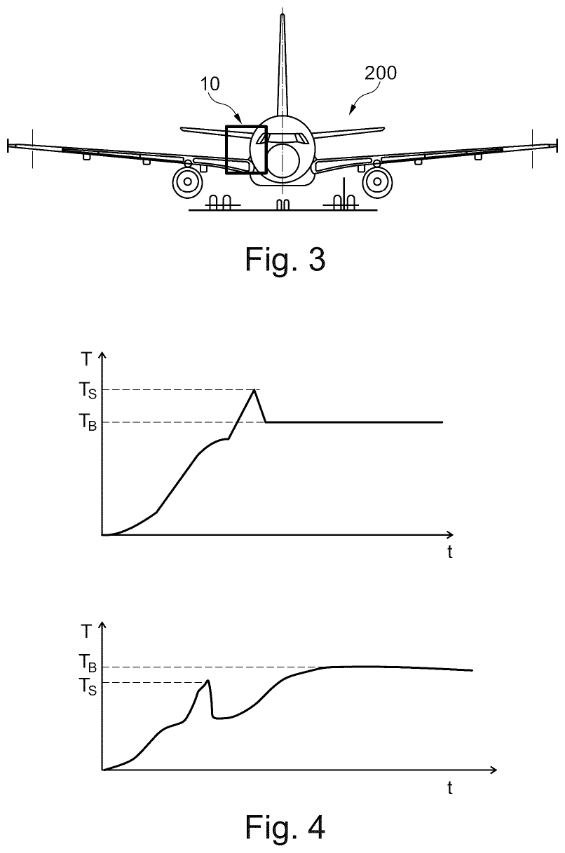

FIG. 3 shows an aircraft 200 equipped with a system 10 for operating a fuel cell with a two-phase cooling system. The system 10 operates according to the principles described above for reducing temperature peaks during start-up and for efficient cooling of the fuel cell.

The aircraft 200 integrates the system 10 into its overall structure. The fuel cell 12, the pressure controller 14 and the coolant circuit 16 are specially adapted to the requirements of the aircraft.

The system 10 enables the aircraft 200 to generate energy in an environmentally friendly and efficient manner. The fuel cell generates electrical energy here from the supplied fuel and atmospheric oxygen, while the two-phase cooling system ensures an optimum operating temperature, wherein the boiling delay takes place in the range below the operating temperature.

FIG. 4 shows two graphs in which the temperature of a fuel cell 12 is plotted over time. The upper graph shows that the maximum temperature Ts induced by the boiling delay is above the operating temperature TB. This can lead to the undesirable effects described.

The lower graph shows the temperature curve insofar as the saturation pressure of the coolant is set to a second saturation pressure via the pressure controller in response to the maximum temperature of the coolant induced by boiling delay being exceeded. The second saturation pressure is higher than the first saturation pressure.

As a result, the maximum temperature Ts induced by boiling delay is lower and lies below the operating temperature TB, which improves the operating behavior of the fuel cell.

In addition, it should be noted that “comprising” or “having” does not exclude other elements or steps and “one” or “a” does not exclude a plurality. Furthermore, it should be noted that features or steps described with reference to one of the above example embodiments may also be used in combination with other features or steps of other example embodiments described above. Reference signs in the claims are not to be regarded as a limitation.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 system
12 fuel cell
14 pressure controller, accumulator
16 coolant circuit
18 heat exchanger
20 pump
100 method for reducing temperature peaks
102 setting a first saturation pressure
104 starting the fuel cell
106 setting a second saturation pressure
200 aircraft
TB maximum operating temperature of the fuel cell
Ts maximum temperature due to boiling delay

1. A method for reducing temperature peaks during start-up of a fuel cell having a two-phase cooling system, the method comprising:
setting a saturation pressure of a coolant, via a pressure controller, to a first saturation pressure such that a maximum temperature of a coolant induced by boiling delay is below a maximum operating temperature of the fuel cell;
starting the fuel cell;
in response to the maximum temperature of the coolant induced by boiling delay being exceeded, setting the saturation pressure of the coolant, via the pressure controller, to a second saturation pressure, wherein the second saturation pressure is higher than the first saturation pressure.

2. The method of claim 1, wherein the pressure controller is an accumulator.

3. The method of claim 2, wherein the accumulator is connected to an outlet of the fuel cell and is configured to separate a vapor and liquid phase of the coolant from each other.

4. The method of claim 2, wherein the accumulator is arranged to adjust a temperature of the coolant.

5. The method of claim 2, wherein the accumulator is configured to adjust pressure of the coolant.

6. The method of claim 1, wherein the pressure controller is a combination of a pump and a throttle valve.

7. The method of claim 1, wherein the first saturation pressure is in a range from 0 bar to 10 bar, or from 0 bar to 5 bar, or is 1.25 bar.

8. The method of claim 1, wherein the second saturation pressure is in a range from 0 bar to 10 bar, or from 0 bar to 5 bar, or is 3 bar.

9. The method of claim 1, wherein the maximum temperature of the coolant induced by boiling delay is 50% to 100% of the operating temperature, or 60% to 90% of the operating temperature, or 70% to 80% of the operating temperature.

10. The method of claim 1, wherein the coolant comprises methanol and/or ethanol.

11. A system for operating a fuel cell with a two-phase cooling system, wherein the system is configured to perform the method of claim 1 for reducing temperature peaks during start-up, the system comprising:
at least one fuel cell;
a pressure controller;
a heat exchanger;
a coolant circuit;
wherein the coolant circuit is configured to cool the fuel cell by two-phase cooling via the heat exchanger, and
wherein the pressure controller is configured to set a saturation pressure of a coolant contained in the coolant circuit.

12. An aircraft comprising the system of claim 11.
